(19) United States
(12) Patent Application Publication
(10) Pub. No.: US 2005/0228622 A1
(43) Pub. Date: Oct. 13, 2005

(54) Graphical user interface for risk assessment

(76) Inventor: Norman R. Jacobi, Sunnyvale, CA (US)

Correspondence Address: MOSER, PATTERSON & SHERIDAN, Suite 1500, 3040 Post Oak Blvd., Houston, TX, 77056, US

(21) Appl. No.: 10/818,296

(22) Filed: Apr. 5, 2004

(51) Int. Cl. G06F 17/10

(52) U.S. Cl. 703/2

(57) ABSTRACT

A system, method and article of manufacture for creating risk maps for risk assessment and management and, more particularly, for creating risk maps for graphically displaying different characteristics of risks. One embodiment provides a method of creating a risk map for graphically displaying characteristics of risks. The method includes determining N selected risks from a plurality of potential risks, where N is an integer; determining, for each of the N selected risks, a probability of occurrence, a relative severity of occurrence, and a risk evaluation factor; and displaying, for each of the N selected risks, the probability of occurrence, the relative severity of occurrence and the risk evaluation factor.

### BACKGROUND OF THE INVENTION

1. Field of the Invention

The present invention generally relates to risk assessment and, more particularly, to creating risk maps for risk assessment.

2. Description of the Related Art

Risk assessment is a key task in today's businesses for measuring, valuing and pricing potential risks for companies. Once information about potential risks for a company has been identified, quantified and measured, this information can be used for purposes of risk management. Risk management facilitates more confident decision-making about potential risks with respect to potential damages and corresponding possible adverse affects for a company. In general, two main risk management types can be distinguished: insurance risk management (IRM) and enterprise risk management (ERM). In IRM, the information about potential risks to which companies are exposed is used by insurance companies to determine accurate premiums of insurance policies for the companies. In ERM, the information is used by the companies themselves to estimate potential damages and to take precautions against the corresponding possible adverse affects. More specifically, ERM is directed to helping companies manage risks the companies are exposed to with a view to reducing uncertainty of operation. Generally, ERM uses risk assessment techniques for correlating a probability of occurrence of risk with an estimated relative cost of occurrence. The correlation of the probability of occurrence with the estimated relative cost can be graphically represented in a so-called “risk map”. Using a risk map, a company can assess and manage potential risks, for instance, by reviewing internal processes in order to improve procedures and practices, thereby mitigating risks and/or reducing potential damages in the event of an occurrence.

While conventional risk assessment techniques provide an adequate picture of many companies' risk exposure, the same risk assessment techniques fail to provide meaningful information to other types of business. Technology and communications industries, for example, evolve through explosive worldwide growth, deregulation, advances in technology, increasing internet usage and relentless innovation. Therefore, today's technology and telecommunications companies function in an environment where profound change is a constant. Consequently, prospering on the leading edge of the market requires continuous innovations which become a key object for today's technology and telecommunications companies. As a result, many technology and telecommunications companies frequently roll out new products in order to maintain a competitive advantage. As a result of these dynamic market conditions, the risk exposure for these companies cannot be quantified or qualified using conventional risk assessment techniques, which assume a more or less stabile business environment.

Therefore, there is a need for an improved and more flexible risk assessment technique for creating risk maps representing potential risks.

### SUMMARY OF THE INVENTION

The present invention is generally directed to a method, system and article of manufacture for creating risk maps for risk assessment and management and, more particularly, for creating risk maps for graphically displaying different characteristics of risks.

One embodiment provides a method of creating a risk map for graphically displaying characteristics of risks. The method includes determining N selected risks from a plurality of potential risks, where N is an integer; determining, for each of the N selected risks, a probability of occurrence, a relative severity of occurrence, and a risk evaluation factor; and displaying, for each of the N selected risks, the probability of occurrence, the relative severity of occurrence and the risk evaluation factor.

Another embodiment provides a method of displaying risk maps for graphically displaying characteristics of risks. The method includes displaying a two-dimensional graph having an x-axis representing a probability of occurrence of risk and a y-axis representing the relative severity of occurrence of risk; plotting a plurality of data points on the two-dimensional graph and each representing a different risk type; displaying a first type of a graphical object collocated with each of the plurality of data points, the first type of a graphical object representing a first risk evaluation factor for a first risk map; and displaying a second type of a graphical object collocated with each of the plurality of data points, the second type of a graphical object representing a second risk evaluation factor for a second risk map.

Still another embodiment provides a graphical user interface residing in computer readable medium and including a graphical representation of a risk map. The risk map includes a plurality of data points, each data point being associated with a potential risk and indicating a probability of occurrence of the potential risk and a relative severity of occurrence of the potential risk; and a graphical object collocated with each of the plurality of data points and representing a risk evaluation factor of the potential risk.

Still another embodiment provides a graphical user interface residing in computer readable medium and configured for displaying a plurality of graphical risk maps. The risk maps include a two-dimensional graph having an x-axis representing a probability of occurrence of risk and a y-axis representing a relative severity of occurrence of risk; a plurality of data points plotted on the two-dimensional graph and each representing a different risk type; and a plurality of graphical objects of different types, each type of graphical object being selectively displayable on the plurality of data points and each representing a different risk evaluation factor for a particular risk map.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a data processing system illustratively utilized in accordance with the invention;

FIGS. 2-6 are screen shots illustrating risk maps in one embodiment; and

FIG. 7 is a flow chart illustrating creation of risk maps in one embodiment.

### DETAILED DESCRIPTION OF THE PREFERRED EMBODIMENTS INTRODUCTION

The present invention generally is directed to a system, method and article of manufacture for risk assessment and, more particularly, for creating risk maps for risk assessment. The risk maps are suitable for graphically displaying and prioritizing potential risks a company is exposed to. According to one aspect, an inventory of potential risks a company is exposed to is provided by a user. The user selects one or more of the risks from the inventory which are considered to be significant risks for the company. For the selected risks, one or more risk maps are created.

In one embodiment, a risk map is created for graphically displaying characteristics of the selected risks. The risk map is configured to provide information about the selected risks in the context of a predefined evaluation characteristic associated with the risk map. Therefore, a probability of occurrence, a relative severity of occurrence, and a risk evaluation factor are determined for each of the selected risks. For a given selected risk, the relative severity of occurrence can be defined as a Probable Maximum Loss (PML). According to one aspect, the PML is defined as 95% of losses in a standard sampling of losses for the given selected risk. A given risk evaluation factor quantifies the evaluation characteristic of the risk map for the given selected risk. Then, for each of the selected risks, the probability of occurrence, the relative severity of occurrence and the risk evaluation factor are displayed in a graphical user interface (GUI). Therefore, according to one aspect, the probability of occurrence and the relative severity of occurrence of each selected risk are plotted as a data point on a two-dimensional graph displayed in the GUI. In the two-dimensional graph, each data point is collocated with a graphical object representing the respective risk evaluation factor. As defined here, “collocated” refers to an association which can be visually appreciated. For example, the risk evaluation factor objects can be superimposed on the data points, adjacent to the data points or viewed as fly-over text when a mouse pointer is positioned over the corresponding data point.

In another embodiment, a GUI configured for displaying a plurality of graphical risk maps is provided. Each risk map includes a two-dimensional graph having an x-axis representing a probability of occurrence of risk and a y-axis representing a relative severity of occurrence of risk. On the two-dimensional graph a plurality of data points is plotted, each representing a different risk type. Moreover, a plurality of graphical objects of different types, each representing a different risk evaluation factor for a particular risk map are displayed on the two-dimensional graph. Therein, each type of graphical object is selectively displayable on the plurality of data points.

It is noted that particular embodiments described herein may refer to creating risk maps for a specific risk management type. For example, embodiments may be described with reference to ERM. However, these references are merely for purposes of illustration and not limiting of the invention. Thus, it is broadly contemplated that creating risk maps for ERM may include creating risk maps for any other suitable risk management type, such as insurance risk management, operational risk management, financial risk management or information risk management.

Data Processing Environment

One embodiment of the invention is implemented as a program product for use with a computer system. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

Embodiments of the invention can be implemented in a hardware/software configuration including at least one client computer and at least one server computer. The client(s) and server(s) may be executing on a common machine or may be deployed in distributed environment in which the client(s) and server(s) communicate via a network. However, the client-server model is merely one model in which the present invention may be implemented, and persons skilled in the art will recognize other possibilities. Furthermore, embodiments of the present invention can apply to any comparable hardware configuration, regardless of whether the computer systems are complicated, multi-user computing apparatus, single-user workstations, or network appliances that do not have non-volatile storage of their own. Further, it is understood that while reference may be made to particular software products, the invention is not limited to a particular software product, standard or version. Accordingly, persons skilled in the art will recognize that the invention is adaptable to other software products and that the invention is also adaptable to future versions of a particular software product as well as to other suitable software products presently unknown.

### Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

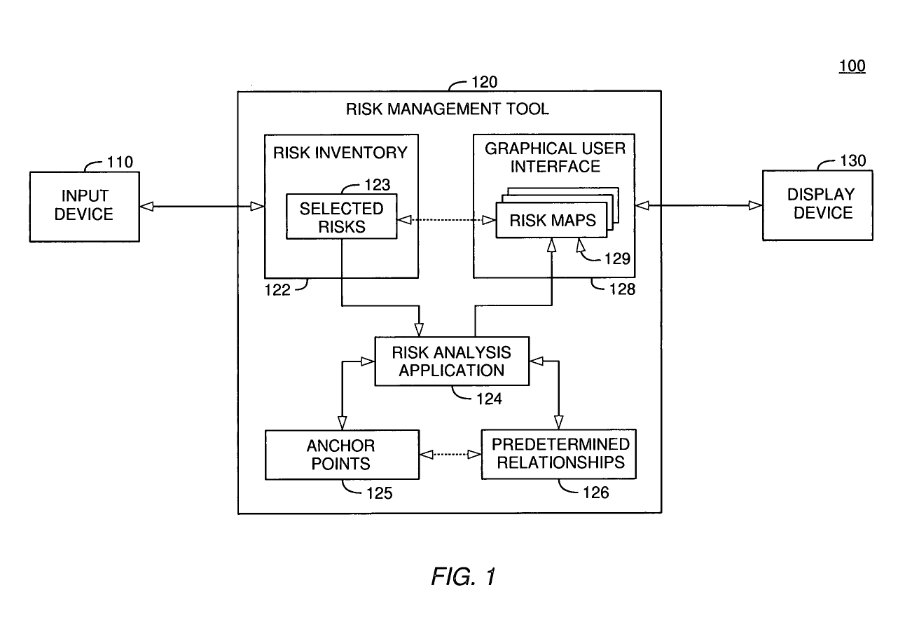

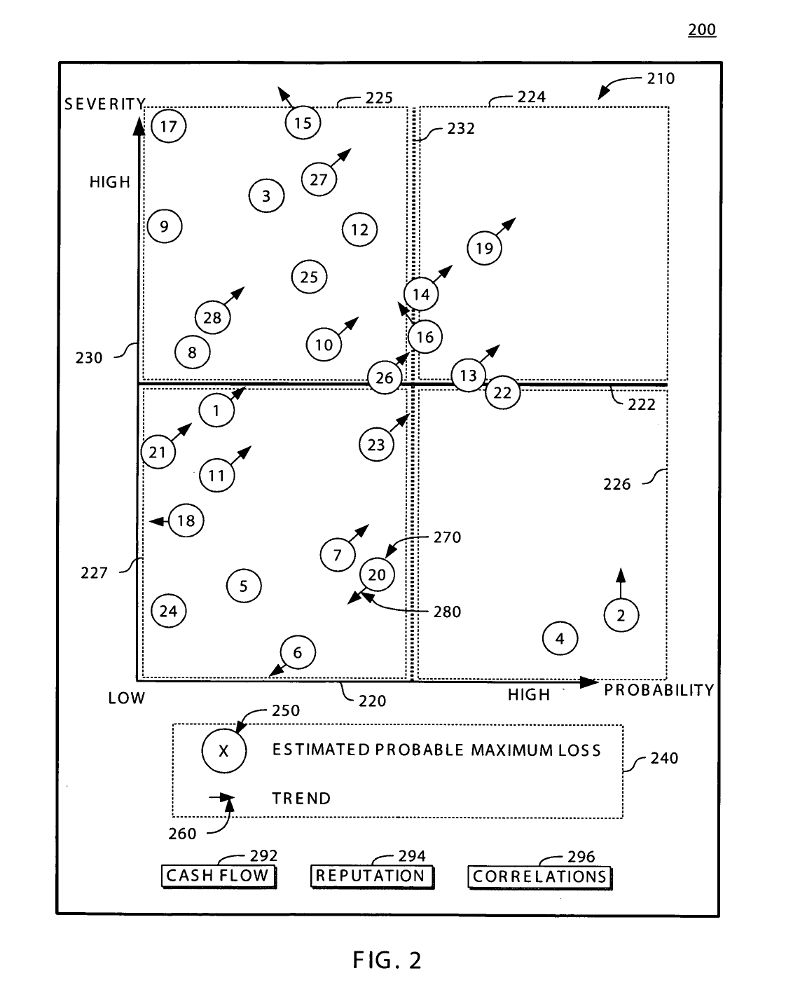

Referring now to FIG. 1, a block diagram of one embodiment of a data processing system 100 is illustrated. The data processing system 100 illustratively includes an input device 110, a risk management tool 120 and a display device 130. The risk management tool 120 is configured for managing potential risks a company is exposed to. More specifically, the risk management tool 120 is configured for creation of one or more risk maps 129 (hereinafter referred to as the risk maps 129) for graphically displaying characteristics of selected risks 123 for risk assessment. The risk maps 129 may be viewed in a graphical user interface (GUI) 128 on the display device 130. Operation of the risk management tool 120 for risk assessment is described in more detail below with reference to FIGS. 2-7.

More specifically, according to one aspect a user provides an inventory 122 of potential risks a company is exposed to using the input device 110. The input device 110 can be any suitable input device for entering input and commands, such as a keyboard, a computer mouse, a light pen or a human finger in the case of a touch screen, a stylus (e.g., in the case of a handheld computer or personal digital assistant) or any other suitable pointing device. Using the input device 110, the user then selects one or more of the potential risks from the inventory 122 as selected risks 123. In one embodiment, the selected risks 123 may be the most significant risks for the company. Subsequently, the risk management tool 120 performs risk assessment for the selected risks 123 using a risk analysis application 124.

In one embodiment, the risk analysis application 124 determines for each one of the selected risks 123 a probability of occurrence and a relative severity of occurrence. The determined probability of occurrence and the relative severity of occurrence for each of the selected risks 123 define a data point in each of the risk maps 129. In other words, each data point indicates a correlation between a probability of occurrence of a corresponding selected risk and an associated relative severity of the occurrence. The relative severity may, for instance, indicate a relative cost. To this end, the risk analysis application 124 performs, for example, a risk analysis for one or more of the selected risks 123 on the basis of risk analysis information, such as published industry data, loss experience, professional judgment and/or individual company characteristics.

In one embodiment, the risk analysis application 124 performs the risk analysis for only a subset of the selected risks 123. In this case, all data points which are associated with risks of the subset may be referred to as “anchor points” 125. In other words, the anchor points 125 are data points for which an extensive qualitative and quantitative analysis is performed on the basis of the risk analysis information. Accordingly, the anchor points 125 objectively describe the probability of occurrence and the relative severity of occurrence of the subset of the selected risks 123. The anchor points 125 can then be used to determine all other data points which are associated with the remaining risks of the selected risks 123. To this end, the risk analysis application 124 determines predetermined relationships 126 between the anchor points 125 and the remaining data points associated with the remaining risks of the selected risks 123. In other words, all the remaining data points are determined by a subjective estimation of their probability of occurrence and their relative severity of occurrence.

The risk analysis application 124 then determines a risk evaluation factor for each one of the selected risks 123. In one embodiment, a given risk evaluation factor describes an evaluation characteristic of an associated risk map of the risk maps 129. By way of example, the given risk evaluation factor can describe a future trend of a given risk, a cash flow associated with an occurrence of the given risk event, a reputational impact associated with an occurrence of the given risk event and inter-risk correlations between different risks. However, it should be noted that other risk evaluation factors can be determined and are, therefore, broadly contemplated. In the associated risk map, the given risk evaluation factor is represented as a graphical object. Specifically, an instance of the graphical object is collocated in the associated risk map with each data point determined for the given risk. For instance, if a reputational impact risk map should be created, a risk evaluation factor describing a reputational impact of an occurrence of the risk event is determined for each of the selected risks 123. The determined risk evaluation factors are associated with the corresponding data points of the selected risks 123. The data points are then graphically displayed together with the respective risk evaluation factors in the specific reputational impact risk map. Thus, the specific reputational impact risk map indicates in a single graphical representation a probability of occurrence, a relative severity of occurrence and a reputational impact of occurrence for each one of the selected risks 123.

According to one aspect, a plurality of risk maps is created. For instance, for each of the above described risk evaluation factors a corresponding risk map can be created. Accordingly, for the selected risks 123, a risk map indicating future trends, a risk map indicating the impact on cash flow, a risk map indicating a reputational impact and a risk map indicating inter-risk correlations between the selected risks 123 can be created. All created risk maps can be combined in a single, so-called “risk atlas” displayed in the GUI 128. The risk atlas, thus, provides an overall analysis of the selected risks and potential damages for risk assessment.

In one embodiment, the GUI 128 may display the risk maps 129 in multiple different user interface screens, such as graphical windows. For instance, the GUI 128 may provide a separate window for each one of the risk maps 129. Accordingly, a first window can be used to display the risk map indicating future trends. A second window can be used to display the risk map indicating cash flow. A third window can be used to display the risk map indicating the reputational impact and a fourth window can be used to display the risk map indicating inter-risk correlations. According to predefined parameters, such as system settings or user preferences, the various windows can be displayed sequentially or concurrently. Furthermore, various graphical elements, such as pushbuttons or pull-down menus, can be used to allow a user to navigate through the different windows. Alternatively, graphical elements such as thumbnails can be provided to allow a user to request enlarged views of the different windows. Exemplary graphical windows provided by the risk management tool 120 of FIG. 1 are explained in more detail below with reference to FIGS. 2-6.

Referring now to FIG. 2, an exemplary graphical window 200 displayed on a display device (e.g., display device 130 of FIG. 1) is shown. The graphical window 200 includes an exemplary risk map 210 indicating future trends for a plurality of potential risks (e.g., selected risks 123 of FIG. 1). The risk map 210 is displayed as a two-dimensional graph having an x-axis 220 and a y-axis 230. Illustratively, the x-axis 220 indicates a probability of occurrence of the potential risks and the y-axis indicates a relative severity of occurrence of the potential risks. Illustratively, the two-dimensional graph is divided by a horizontal line 222 and a vertical line 232 into four risk quadrants, as schematically illustrated by dotted rectangles 224, 225, 226 and 227. Each risk quadrant gives an indication of a relative basis importance of the potential risks. More specifically, a potential risk located in quadrant 224 can primarily, i.e., regardless of risk evaluation factors such as future trends, be considered to be of higher relative importance than a potential risk located in quadrant 227.

The risk map 210 includes a plurality of data points, one for each of the potential risks, plotted on the two-dimensional graph, such as for instance data point 270. Illustratively, the data point 270 is collocated with a graphical object 280, which is also referred to as a “trend vector”. Specifically, the graphical object 280 represents a risk evaluation factor indicating a future trend of the potential risk associated with the data point 270.

The risk map 210 is further associated with a legend 240 indicating a meaning of all symbols and graphical objects used in the risk map 210. Accordingly, a legend element 250 indicates that all illustrated data points indicate an estimated probable maximum loss at occurrence of the associated selected risks. A legend element 260 indicates that an arrow collocated with a given data point is a trend vector. By way of example, assume that the data point 270 is associated with a potential risk related to employment practices of a company. The corresponding trend vector 280 for the data point 270 indicates that the future trend for this potential risk is estimated to be decreasing.

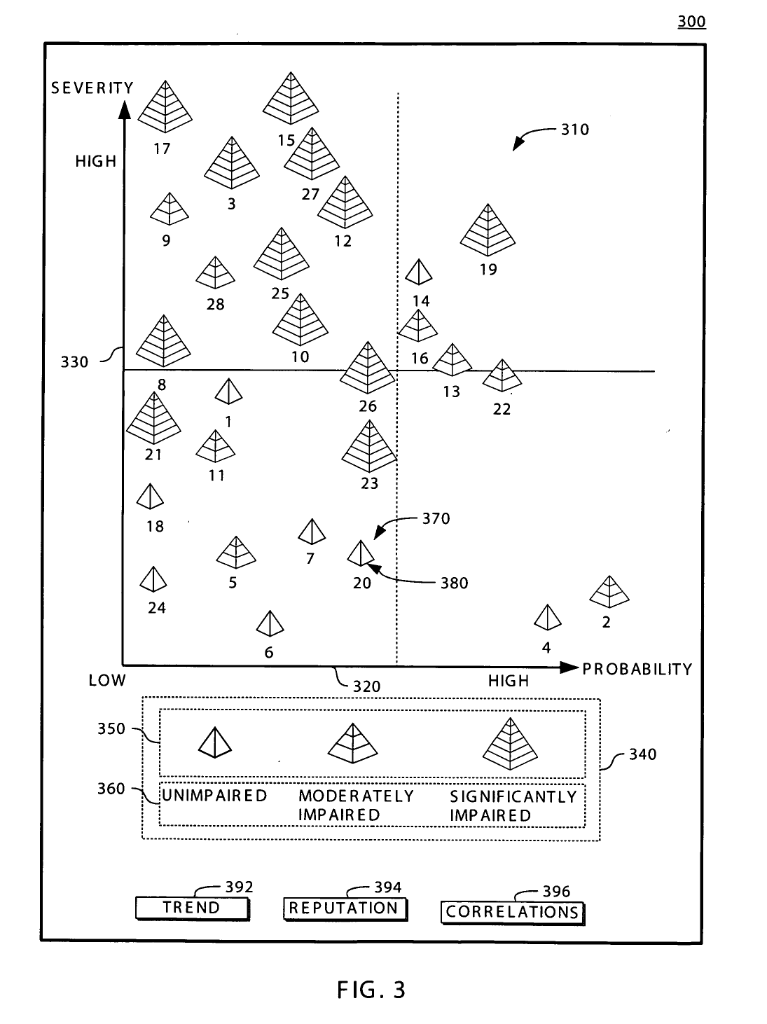

The graphical window 200 further includes three illustrative pushbuttons 292, 294 and 296. In one embodiment, the user can click one of the pushbuttons 292, 294 and 296 using a pointing device, such as a computer mouse, to selectively display another risk map for the potential risks displayed in the risk map 210. For instance, to select a risk map indicating a risk's impact on cash flow, the user can click on the pushbutton 292 using the pointing device. An exemplary graphical window displaying a cash flow risk map is explained in more detail below with reference to FIG. 3.

Referring now to FIG. 3, an exemplary graphical window 300 displayed on a display device (e.g., display device 130 of FIG. 1) is shown. In one embodiment, the graphical window 300 is displayed in response to a click on the pushbutton 292 of FIG. 2. The graphical window 300 illustratively includes an exemplary risk map 310 indicating the impact on cash flow upon occurrence of an event corresponding to the potential risks of FIG. 2. The risk map 310 is displayed as a two-dimensional graph having an x-axis 320 and a y-axis 330. In one embodiment, the x-axis 320 and the y-axis 330 correspond to the x-axis 220 and the y-axis 230 of FIG. 2, respectively. Accordingly, the risk map 310 includes the same plurality of data points of the risk map 210 of FIG. 2, plotted at the same (x,y) locations. Thus, for instance data point 370 corresponds to data point 270 of FIG. 2. The data point 370 is illustratively collocated with a graphical object 380. Specifically, the graphical object 380 represents a risk evaluation factor indicating the impact on cash flow upon occurrence of an event corresponding to the potential risk associated with the data point 370.

The risk map 310 is further associated with a legend 340 describing the graphical objects illustrated in the risk map 310. The legend 340 includes a section 350 showing all graphical objects illustrated in the risk map 310 and a section 360 indicating a meaning of these graphical objects. As can be seen from sections 350 and 360, the graphical objects reflect a quantity of the risk evaluation factor according to a relative visual attribute of the graphical objects, i.e., the size of the graphical objects. Illustratively, the graphical objects are small, medium and large pyramids representing increasing quantitative significance. Accordingly, the graphical object 280 indicates by way of example that cash flow associated with the data point 370 is estimated to be “UNIMPAIRED”. In other words, the potential risk related to employment practices of the company is estimated not to impair cash flow upon occurrence of an event corresponding to the risk.

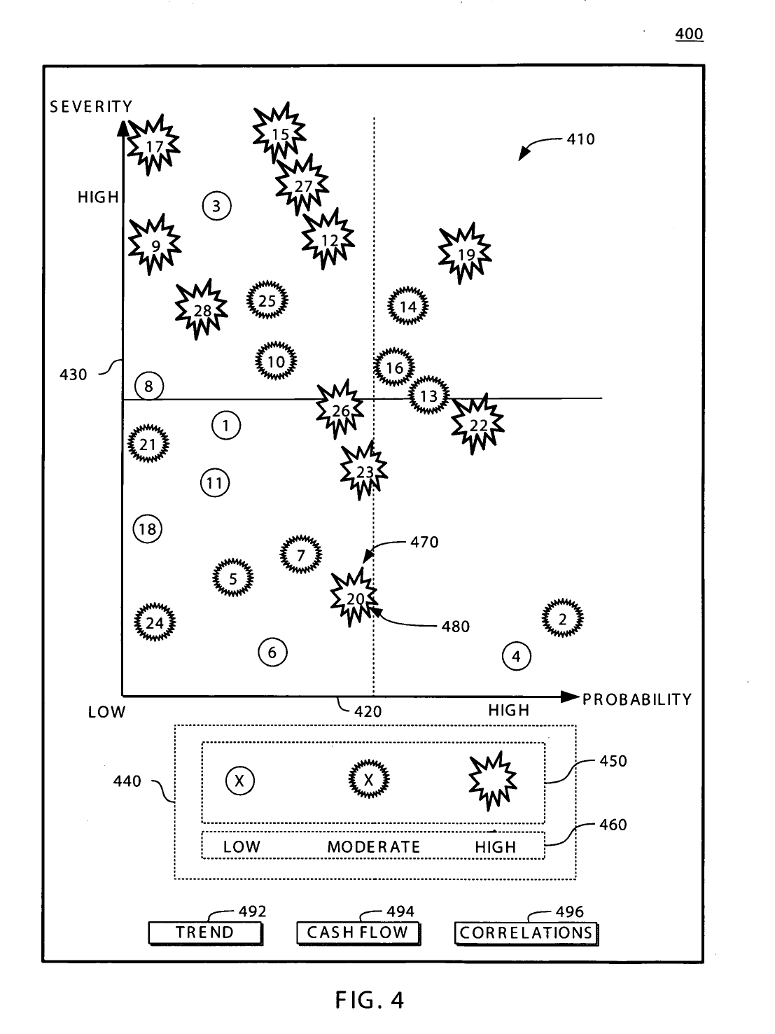

The graphical window 300 further includes three illustrative pushbuttons 392, 394 and 396. In one embodiment, the user can click one of the pushbuttons 392, 394 and 396 using a pointing device, such as a computer mouse, to selectively display another risk map. For instance, to return to the risk map 210 of FIG. 2, the user can click on the pushbutton 392 using the pointing device. Alternatively, in order to select a risk map indicating the reputational impact associated with the potential risks, the user can click on the pushbutton 394 using the pointing device. An exemplary graphical window including a risk map indicating reputational impact is explained in more detail below with reference to FIG. 4.

Referring now to FIG. 4, an exemplary graphical window 400 displayed on a display device (e.g., display device 130 of FIG. 1) is shown. In one embodiment, the graphical window 400 is displayed in response to a click on the pushbutton 394 of FIG. 3. The graphical window 400 illustratively includes an exemplary risk map 410 indicating the reputational impact associated with the potential risks of FIGS. 2 and 3. The risk map 410 is displayed as a two-dimensional graph having an x-axis 420 and a y-axis 430. In one embodiment, the x-axis 420 and the y-axis 430 correspond to the x-axis 220, 320 and the y-axis 230, 330 of FIGS. 2 and 3, respectively. Accordingly, the risk map 410 includes the same plurality of data points (and their respective locations) of the risk maps 210 and 310 of FIGS. 2 and 3. Thus, for instance data point 470 corresponds to data point 270 of FIG. 2. The data point 470 is illustratively collocated with a graphical object 480. Specifically, the graphical object 480 represents a risk evaluation factor indicating reputational impact at occurrence of the potential risk associated with the data point 470.

The risk map 410 is further associated with a legend 440 describing the graphical objects illustrated in the risk map 410. The legend 440 includes a section 450 showing all graphical objects illustrated in the risk map 410 and a section 460 indicating a meaning of these graphical objects. As can be seen from sections 450 and 460, the graphical objects reflect a quantity of the risk evaluation factor according to a relative visual attribute of the graphical objects, i.e., the shape and/or size of the graphical objects. Illustratively, the graphical objects are an oval (corresponding to low reputational impact), a circle having an irregular border (corresponding to moderate reputational impact) and a star (corresponding to high reputational impact). Accordingly, the graphical object 480 indicates that the reputational impact associated with the potential risk represented by the data point 470 is estimated to be “HIGH”. In other words, in the given example the potential risk related to employment practices of the company is estimated to have a high reputational impact at occurrence of the risk.

However, it should be noted that the relative visual attributes described with reference to FIGS. 3 and 4, i.e., the size and shape, are merely illustrative. For instance, other embodiments may include a relative shade of the graphical objects, where a lighter shade indicates quantitatively less and a darker shade indicates quantitatively more. Therefore, such other embodiments are broadly contemplated.

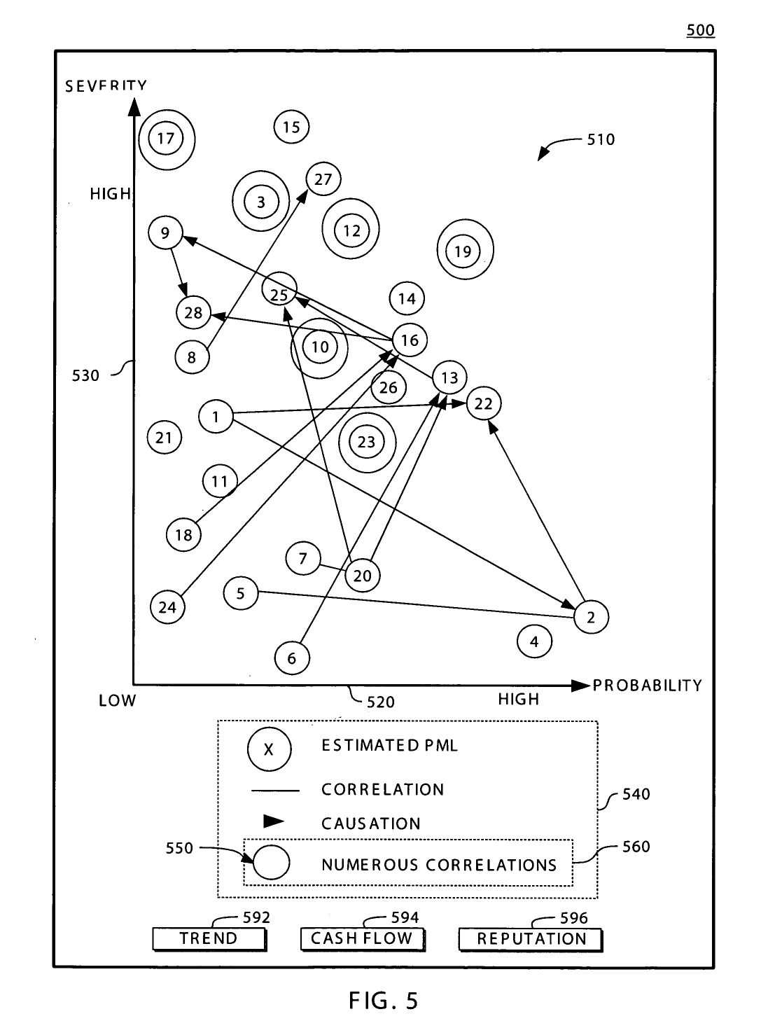

The graphical window 400 further includes three illustrative pushbuttons 492, 494 and 496. In one embodiment, the user can click one of the pushbuttons 492, 494 and 496 using a pointing device, such as a computer mouse, to selectively display another risk map. For instance, to return to the risk map 310 of FIG. 3, the user can click on the pushbutton 494 using the pointing device. Alternatively, in order to select a risk map indicating inter-risk correlations of the potential risks, the user can click on the pushbutton 496 using the pointing device. An exemplary graphical window including a risk map indicating inter-risk correlations is explained in more detail below with reference to FIG. 5.

Referring now to FIG. 5, an exemplary graphical window 500 displayed on a display device (e.g., display device 130 of FIG. 1) is shown. In one embodiment, the graphical window 500 is displayed in response to a click on the pushbutton 496 of FIG. 4. The graphical window 500 illustratively includes an exemplary risk map 510 indicating inter-risk correlations between the potential risks of FIGS. 2, 3 and 4. The risk map 510 is displayed as a two-dimensional graph having an x-axis 520 and a y-axis 530. In one embodiment, the x-axis 520 and the y-axis 530 correspond to the x-axis 220, 320, 420 and the y-axis 230, 330, 430 of FIGS. 2, 3 and 4, respectively. Accordingly, the risk map 510 includes the same plurality of data points (and their respective locations) of the risk maps 210, 310 and 410 of FIGS. 2, 3 and 4. Illustratively, each data point in the risk map 510 is collocated with a graphical object representing a risk evaluation factor indicating inter-risk correlations.

The risk map 510 is further associated with a legend 540 describing the graphical objects illustrated in the risk map 510. The legend 540 shows all graphical objects illustrated in the risk map 510 and indicates a meaning of these graphical objects. For example, a line represents a correlation between two points and an arrow head represents causation (e.g., the risk associated with data point 9 causes the risk associated with data point 28). Further, a legend element 560 indicates that a data point which is collocated with a graphical object 550 has “NUMEROUS CORRELATIONS”. In other words, in the given example the potential risk related to employment practices of the company is estimated to have numerous correlations with other potential risks.

The graphical window 500 further includes three illustrative pushbuttons 592, 594 and 596. In one embodiment, the user can click one of the pushbuttons 592, 594 and 596 using a pointing device, such as a computer mouse, to selectively display another risk map. For instance, to return to the risk map 310 of FIG. 3, the user can click on the pushbutton 594 using the pointing device.

It should be noted that each of the risk maps, i.e., the two-dimensional graphs 310, 410 and 510 illustrated in FIGS. 3-5, respectively, can be divided into four risk quadrants as illustrated in FIG. 2. Therefore, each of the two-dimensional graphs 310, 410 and 510 of FIGS. 3-5 includes schematically adumbrated horizontal and vertical lines corresponding to horizontal line 222 and vertical line 232 of FIG. 2. However, for brevity the risk quadrants are not illustrated and explained in more detail with respect to FIGS. 3-5.

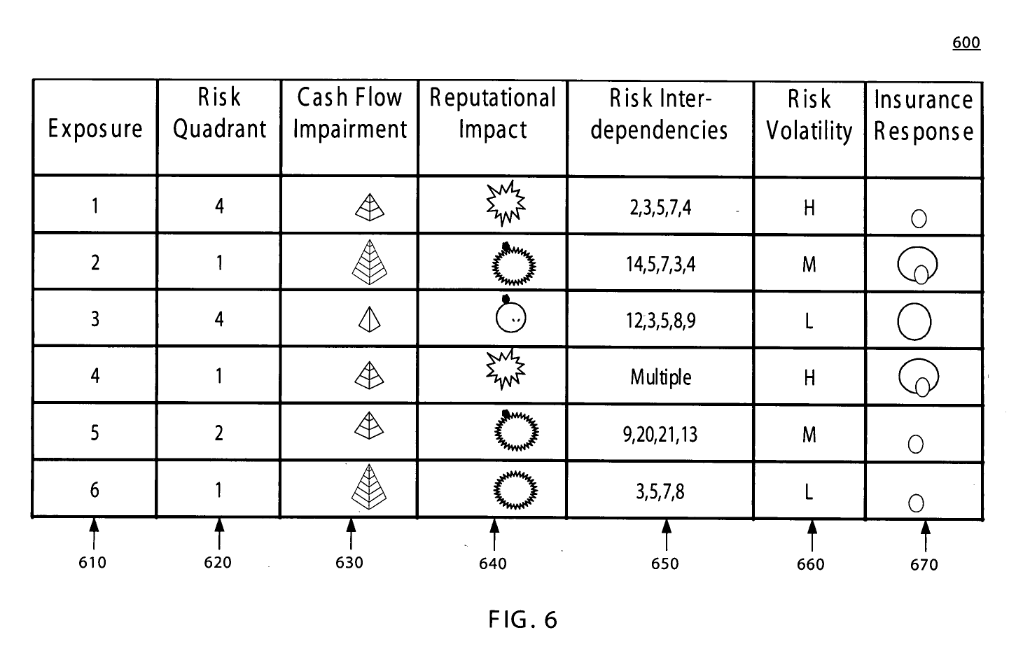

As an alternative to the graphical risk maps described with reference to FIGS. 2-5, the user may wish to visualize information related to the risk maps in tabular form. Accordingly, in various embodiments, the information of a risk atlas can be displayed in a single tabular representation or in a multiplicity of tables, where each table is specific to the various evaluation factors described above. An exemplary GUI 600 including an exemplary tabular representation is explained in more detail below with reference to FIG. 6.

Referring now to FIG. 6, an exemplary tabular representation 600 displayed on a display device (e.g., display device 130 of FIG. 1) is shown. Illustratively, the tabular representation 600 includes a plurality of columns 610-670. Column 610 indicates potential risks (e.g. selected risks 123 of FIG. 1). Column 620 indicates for each potential risk of column 610 a corresponding location, i.e., a quadrant in a two-dimensional graph indicating the probability of occurrence and the relative severity of occurrence of the potential risk (e.g., one of quadrants 224, 225, 226 or 227 of FIG. 2). Columns 630, 640, 650 and 660 include information about risk evaluation factors associated with the potential risks of column 610. Accordingly, column 630 includes information about impact on cash flow, column 640 includes information about reputational impact, column 650 includes information about inter-risk correlations and column 660 includes information about risk volatility, i.e., about future trends. Thus, for instance the column 630 may describe information that is graphically illustrated in a risk map according to FIG. 3. However, it should be noted that the exemplary tabular representation 600 illustrated in FIG. 6 does not correspond to the risk atlas formed of the risk maps shown in FIGS. 2-5, for simplicity. Column 670 illustratively includes a summarizing evaluation for each potential risk. By way of example, column 670 represents a response of an insurance company on whether to accept or decline insurance with respect to a given potential risk.

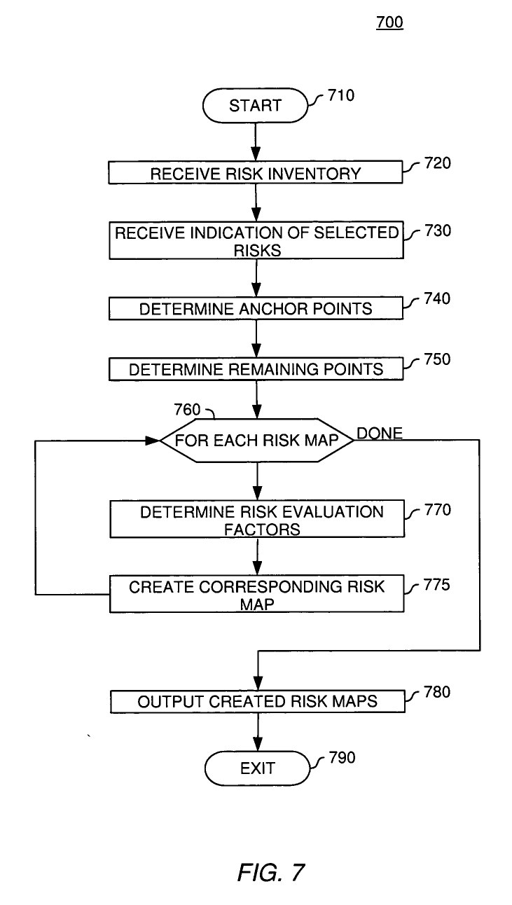

Referring now to FIG. 7, one embodiment of a method 700 for creating one or more risk maps (e.g., risk maps 129 of FIG. 1) for graphically displaying characteristics of potential risks is illustrated. It is contemplated that all or some of the steps of method 700 can be performed by a risk management tool (e.g., risk management tool 120 of FIG. 1). Method 700 starts at step 710.

At step 720, a risk inventory (e.g., risk inventory 122 of FIG. 1) including a plurality of potential risks is received. At step 730, an indication of N selected risks (e.g., selected risks 123 of FIG. 1) is received. For instance, a user can select all risks from the risk inventory which are considered to be significant for the company. At step 740, anchor points are plotted for one or more of the selected risks. Then, at step 750, for all remaining selected risks data points are plotted using predetermined relationships (e.g., predetermined relationships 126 of FIG. 1). For example, the remaining selected risks data points may be confined to within two standard deviations of the mean of the anchor points.

It should be noted that use of predetermined relationships has been described by way of example. However, various techniques can be used for plotting all remaining selected risks data points. For instance, all remaining selected risks data points can be plotted based on a more qualitative estimation using consensus building. According to one aspect, a consensus can be built on the basis of risk management consulting input and advice. Accordingly, these various techniques are broadly contemplated.

At step 760 a loop consisting of steps 760-775 is entered for each risk map to be created. At step 770, for a given risk map, risk evaluation factors are determined with respect to all selected risks. At step 775, graphical objects of the determined risk evaluation factors are collocated with the corresponding data points of the selected risks. When the loop consisting of steps 760-775 has been performed for each risk map to be created, method 700 proceeds with step 780.

At step 780, all created risk maps are output. For instance, the created risk maps are output in GUI 128 of FIG. 1 for display on the display device 130 of FIG. 1. Method 700 then exits at step 790.

While the foregoing is directed to embodiments of the present invention, other and further embodiments of the invention may be devised without departing from the basic scope thereof, and the scope thereof is determined by the claims that follow.

1. A method of creating a risk map for graphically displaying characteristics of risks, comprising:
determining N selected risks from a plurality of potential risks, where N is an integer;
determining, for each of the N selected risks:
(i) a probability of occurrence;
(ii) a relative severity of occurrence; and
(iii) a risk evaluation factor; and
displaying, for each of the N selected risks, the probability of occurrence, the relative severity of occurrence and the risk evaluation factor.

2. The method of claim 1, further comprising:
determining, for each of the N selected risks, another risk evaluation factor; and
displaying, for each of the N selected risks, the probability of occurrence, the relative severity of occurrence and the other risk evaluation factor.

3. The method of claim 1, wherein the relative severity of occurrence describes a relative cost associated with occurrence of the selected risk.

4. The method of claim 1, wherein the risk evaluation factor describes a future trend for the selected risk.

5. The method of claim 1, wherein the risk evaluation factor describes a cash flow associated with occurrence of the selected risk.

6. The method of claim 1, wherein the risk evaluation factor describes a reputational impact at occurrence of the selected risk.

7. The method of claim 1, wherein the risk evaluation factor describes inter-risk correlations.

8. The method of claim 1, wherein the displaying comprises, for each of the N selected risks:
plotting the probability of occurrence and the relative severity of occurrence as a data point on a two-dimensional graph; and
displaying a graphical object collocated with the data point for representing the respective risk evaluation factor.

9. The method of claim 8, wherein the graphical object comprises:
a trend vector indicating a trend of the Nth selected risk with respect to the probability of occurrence and the relative severity of occurrence.

10. The method of claim 8, wherein the graphical object quantifies the risk evaluation factor according to a relative size of the graphical object.

11. The method of claim 10, further comprising displaying a legend for the graphical object.

12. The method of claim 8, wherein the graphical object quantifies the risk evaluation factor according to a relative shape of the graphical object.

13. The method of claim 12, further comprising displaying a legend for the graphical object.

14. The method of claim 1, further comprising:
receiving user input specifying a risk inventory including the plurality of potential risks.

15. The method of claim 1, wherein the determining of the N selected risks is performed in response to user input.

16. The method of claim 1, further comprising:
determining, for a subset of the N selected risks, the probability of occurrence and the relative severity of occurrence;
determining predefined relationships between the subset and the remaining risks of the N selected risks; and
determining, for each one of the remaining risks, the probability of occurrence and the relative severity of occurrence on the basis of the predefined relationships.

17. The method of claim 1, wherein determining the probability of occurrence, the relative severity of occurrence and the risk evaluation factor is performed on the basis of a statistical analysis.

18. The method of claim 1, wherein determining the probability of occurrence and the relative severity of occurrence is performed on the basis of at least one of:
(i) published industry data;
(ii) loss experience;
(iii) professional judgment; and
(iv) individual company characteristics.

19. A method of displaying risk maps for graphically displaying characteristics of risks, comprising:
displaying a two-dimensional graph having an x-axis representing a probability of occurrence of risk and a y-axis representing the relative severity of occurrence of risk;
plotting a plurality of data points on the two-dimensional graph and each representing a different risk type;
displaying a first type of a graphical object collocated with each of the plurality of data points, the first type of a graphical object representing a first risk evaluation factor for a first risk map; and
displaying a second type of a graphical object collocated with each of the plurality of data points, the second type of a graphical object representing a second risk evaluation factor for a second risk map.

20. The method of claim 19, further comprising:
displaying a third type of a graphical object collocated with each of the plurality of data points, the third type of a graphical object representing a third risk evaluation factor for a third risk map.

21. The method of claim 19, further comprising:
displaying at least one user-selectable graphical element associated with the two-dimensional graph for selectively viewing each of the graphical objects of the first and second types on the two-dimensional graph with the same plurality of plotted data points.

22. The method of claim 21, further comprising navigating between the first and second risk maps using the at least one user-selectable graphical element.

23. The method of claim 19, wherein each type of graphical object reflects a quantity of the respective risk evaluation factor according to a relative visual attribute of the graphical object.

24. The method of claim 23, wherein the relative visual attribute is a size of the graphical object.

25. The method of claim 23, wherein the relative visual attribute is a shape of the graphical object.

26. The method of claim 19, further comprising:
determining N selected risk types from a plurality of potential risk types, where N is an integer;
determining, for each of the N selected risk types:
(i) the probability of occurrence;
(ii) the relative severity of occurrence;
(iii) the first risk evaluation factor; and
(iv) the second risk evaluation factor.

27. A graphical user interface residing in computer readable medium and comprising a graphical representation of a risk map, the risk map comprising:
a plurality of data points, each data point being associated with a potential risk and indicating:
(i) a probability of occurrence of the potential risk; and
(ii) a relative severity of occurrence of the potential risk; and
a graphical object collocated with each of the plurality of data points and representing a risk evaluation factor of the potential risk.

28. The graphical user interface of claim 27, wherein the relative severity of occurrence describes a relative cost associated with occurrence of the potential risk.

29. The graphical user interface of claim 27, wherein the risk evaluation factor describes a future trend for the potential risk.

30. The graphical user interface of claim 27, wherein the risk evaluation factor describes a cash flow associated with occurrence of the potential risk.

31. The graphical user interface of claim 27, wherein the risk evaluation factor describes a reputational impact at occurrence of the potential risk.

32. The graphical user interface of claim 27, wherein the risk evaluation factor describes inter-risk correlations.

33. The graphical user interface of claim 27, wherein the graphical representation comprises a two-dimensional graph having an x-axis representing the probability of occurrence and a y-axis representing the relative severity of occurrence of the potential risk.

34. The graphical user interface of claim 33, wherein the graphical object comprises:
a trend vector indicating a trend of the Nth selected risk with respect to the probability of occurrence and the relative severity of occurrence;

35. The graphical user interface of claim 33, wherein the graphical object quantifies the risk evaluation factor according to a relative size of the graphical object.

36. The graphical user interface of claim 35, further comprising a representation of a legend for the graphical object.

37. The graphical user interface of claim 33, wherein the graphical object quantifies the risk evaluation factor according to a relative shape of the graphical object.

38. The graphical user interface of claim 37, further comprising a representation of a legend for the graphical object.

39. A graphical user interface residing in computer readable medium and configured for displaying a plurality of graphical risk maps, the risk maps comprising:
a two-dimensional graph having an x-axis representing a probability of occurrence of risk and a y-axis representing a relative severity of occurrence of risk;
a plurality of data points plotted on the two-dimensional graph and each representing a different risk type; and
a plurality of graphical objects of different types, each type of graphical object being selectively displayable on the plurality of data points and each representing a different risk evaluation factor for a particular risk map.

40. The graphical user interface of claim 39, wherein a particular type of graphical object is a trend indicator indicating a trend of a given risk type with respect to the probability of occurrence and the relative severity of occurrence of the given risk type.

41. The graphical user interface of claim 39, wherein a particular type of graphical object quantitatively reflects the respective risk evaluation factor according to a relative visual attribute of the graphical object.

42. The graphical user interface of claim 41, wherein the relative visual attribute is a size of the graphical object.

43. The graphical user interface of claim 41, wherein the relative visual attribute is a shape of the graphical object.

44. The graphical user interface of claim 39, further comprising user-selectable graphical elements for selectively viewing each of the plurality of graphical objects of different types on the two-dimensional graph with the same plurality of plotted data points.
